(19) United States
(12) Patent Application Publication
(10) Pub. No.: US 2026/0085554 A1
(43) Pub. Date: Mar. 26, 2026

(54) INTERIOR DOOR HANDLE MECHANISM WITH A LINEAR PULLING DEVICE

(71) Applicant: Minebea Accesssolutions South America Ltda., GUARULHOS (BR)

(72) Inventor: Elio PINHEIRO, GUARULHOS (BR)

(73) Assignee: Minebea Accesssolutions South America Ltda., GUARULHOS (BR)

(21) Appl. No.: 19/334,026

(22) Filed: Sep. 19, 2025

(30) Foreign Application Priority Data
Sep. 20, 2024 (EP) 24201602.0

(51) Int. Cl. E05B 85/12; E05B 15/00; E05B 79/20

(52) U.S. Cl. CPC E05B 85/12; E05B 15/0086; E05B 79/20

(57) ABSTRACT

An interior door handle mechanism for a vehicle includes: a support; a moving grip configured to cooperate with the support, the moving grip being movable between a rest position and a pulled position with respect to the support; and a linear pulling device arranged to cooperate with the support and the moving grip. The linear pulling device is arranged to link the moving grip and an opening cable of the vehicle. The linear pulling device is configured to pull on the opening cable by displacing a connection point of the opening cable with the linear pulling device according to the main axis only when the moving grip is moved from the rest position to the pulled position.

### CROSS-REFERENCE TO RELATED APPLICATIONS

This application claims priority to and the benefit of EP 24201602.0, filed on Sep. 20, 2024. The disclosure of the above application is incorporated herein by reference.

### FIELD

The present disclosure relates to an interior door handle mechanism with a linear pulling device.

### BACKGROUND

The statements in this section merely provide background information related to the present disclosure and may not constitute prior art.

It is known to have handles that are located in the interior of a vehicle for opening doors or compartments such as the engine compartment, the filler door, the trunk or a passenger door.

A possibility for opening such a door is to have a dedicated mechanism that pulls an internal steel cable of the vehicle that is linked to the door or compartment that has to be opened.

Usually, when the steel cable is pulled, the corresponding door or compartment opens is set in an openable position, the user having then to displace said door or compartment.

When the tension on the cable is released, the door or compartment can return to its initial closed position. This is especially true for a passenger door handle where a grip of the handle is moved by the user for opening said passenger door, the corresponding cable returning to its initial position when the user releases the grip after exiting the vehicle.

A possibility is to have a rotating grip that moves around an axis made in the rest part of the handle. This rotation moves internal parts of the dedicated mechanism for pulling the cable.

This kind of handle and dedicated mechanism often comprises several pieces that cooperate together to pull the steel cable in response to the displacement of the grip of the handle.

As a result, such a dedicated mechanism can comprise a lot of parts which can be arranged in a complex way so that the steel cable is correctly pulled relatively to the movement of the grip of the handle.

Moreover, this type of mechanism is often bulky which creates difficulties for integrating it in some places of the vehicle. There is a need for an easy to integrate handle mechanism.

### SUMMARY

This section provides a general summary of the disclosure and is not a comprehensive disclosure of its full scope or all of its features.

The present invention aims to solve all or some of the disadvantages mentioned above.

For this purpose, the present invention relates to an interior door handle mechanism for a vehicle and includes: a support extending according to a main axis, the support being configured to be mounted to a receiving location made within an interior lining of the vehicle; a moving grip configured to cooperate with the support, the moving grip being movable between a rest position and a pulled position with respect to the support; and a linear pulling device arranged to cooperate with the support and the moving grip. The linear pulling device is arranged to link the moving grip and an opening cable of the vehicle. The linear pulling device is configured to pull on the opening cable by displacing a connection point of the opening cable with the linear pulling device according to the main axis only when the moving grip is moved from the rest position to the pulled position.

In other words, the linear pulling device enables to displace the opening cable linearly according to the main axis. The opening cable presents a connection point which cooperates with the linear pulling device and which is displaced linearly.

The movement of the moving grip is then transformed in a linear movement for applying a tension on the opening cable. As the opening cable is moved linearly, the linear pulling device can be small and easy to integrate within the vehicle. This is especially true when compared to a mechanism which makes the connection point rotate to tension the opening cable.

The interior door handle mechanism can then be applied to doors or compartments of the vehicle whose opening or openable state is triggered by an opening cable of the vehicle.

According to an aspect of the invention, the opening cable is a steel cable or a cable in a material with properties equivalent to the properties of steel.

According to an aspect of the invention, the linear pulling device comprises a lever rotatably mounted on the moving grip so as to rotate around a rotation axis that is transversal to the main axis, the lever being arranged to cooperate with a linear guide of the support that extends according to the main axis.

The lever is a unique intermediate element between the moving grip and the support. Preferably, the moving grip is provided with a rotation axle that extends according to the rotation axis and that is configured to cooperate with a rotation opening of the lever.

According to an aspect of the invention, the linear guide is an oblong opening within the support, the lever presenting a translation axle configured to be guided within the oblong opening.

When the lever rotates, the translation axle is moving according to the main axis between the rest position and the pulled position. The translation axle comprises a fixation arranged to cooperate with the connection point of the opening cable.

According to an aspect of the invention, the moving grip is rotatably mounted on the support, the moving grip being movable between the rest position and the pulled position according to an actuating axis with respect to the support.

It appears that the rotating movement of the moving grip is transformed by the linear pulling device into a linear displacement of the opening cable. This advantageous configuration enables to have a small interior handle mechanism in particular transversally to the main axis. Indeed, the support extends mainly according to the main axis.

In addition, as the moving grip moves, the rotation axis also moves around the actuating axis. Thus, when the moving grip is manually displaced between the rest position and the pulled position, the lever is displaced, one end by rotation and the other by translation, so as to pull on the opening cable.

According to an aspect of the invention, the moving grip presents an overall elongated form extending according to a corresponding extension axis, said extension axis forming an angle with the main axis that is getting smaller when moving from the rest position to the pulled position.

This provision enables to easily place the interior handle mechanism within the vehicle as a supplementary space is not needed for the moving grip when moving towards to the pulled position. Indeed, the interior handle mechanism takes less space in pulled position.

According to an aspect of the invention, the interior door handle mechanism comprises a return element configured to cooperate with the support and with the moving grip so as to move the moving grip in rest position when the moving grip is not moved manually.

This provision facilitates the use of the interior handle mechanism as by default the moving grip remains or moves to the rest position.

According to an aspect of the invention, the return element is a torsion spring, each extremity of the torsion spring being configured to cooperate with a corresponding shoulder of the support and the moving grip. The torsion spring is configured to move its extremities around the actuating axis.

According to an aspect of the invention, the support includes an adapter configured to fix a fitting of a sheath of the vehicle receiving the opening cable.

The adapter also extends transverse to the rotation axis and the actuating axis. As the sheath is fixed to the adapter, in absence of a solicitation, the opening cable is maintained by the lever and the sheath by the adapter so that the lever always has the same orientation. This defines the rest position.

According to an aspect of the invention, the adapter presents a slot for inserting the fitting of the sheath and shoulders to prevent a move from the fitting transversally to the slot. The slot enables to install manually the fitting and withdraw it if necessary.

According to an aspect of the invention, the support presents at least one fixation opening for installation within the vehicle.

The support is a part that remains fixed with respect to the rest of the vehicle. The at least one fixation opening enables to install the support within the vehicle thanks to corresponding fixing means as screws.

According to an aspect of the invention, the at least one fixation opening is extending in parallel to the actuating axis and to the rotation axis.

The invention also concerns an interior part of the vehicle comprising an interior door handle mechanism as described above, wherein the interior part has one receiving location wherein the interior handle mechanism is received so that at least a part of the moving grip is accessible in the rest position.

The overall design of the interior part hides almost every part of the interior handle mechanism for its protection except a part of the moving grip which is visible and accessible by a user.

In other words, said part of the moving grip extends from the receiving location in the rest position. In pulled position, the moving grip is pushed within the receiving location by the user to pull the opening cable.

According to an aspect of the invention, said interior part is a handle assembly including electronics configured to lock and unlock a closing mechanism of a door, the interior handle mechanism being also configured to lock and unlock said closing mechanism.

The interior handle mechanism is a redundant mechanism that can be used when the electronics is not working, for example during a failure of the vehicle. Due to its geometry, the interior handle mechanism can be installed in a discreet place so that the handle assembly appears as the main command to open the door.

The present invention concerns a door of the vehicle and also concerns a vehicle comprising said door.

The different aspects defined above that are not incompatible can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view of an interior handle mechanism;

FIG. 2 is a perspective view of the interior handle mechanism in a rest position;

FIG. 3 is a perspective view of the interior handle mechanism in a pulled position;

FIG. 4 is an exploded view of the interior handle mechanism;

FIG. 5 is a perspective view of a door with the interior handle mechanism; and

FIG. 6 is a perspective view of the door with the interior handle mechanism, a cover of the door being removed to let said mechanism appear.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or the elements that are fulfilling identical functions may retain the same references so as to simplify the understanding of the invention.

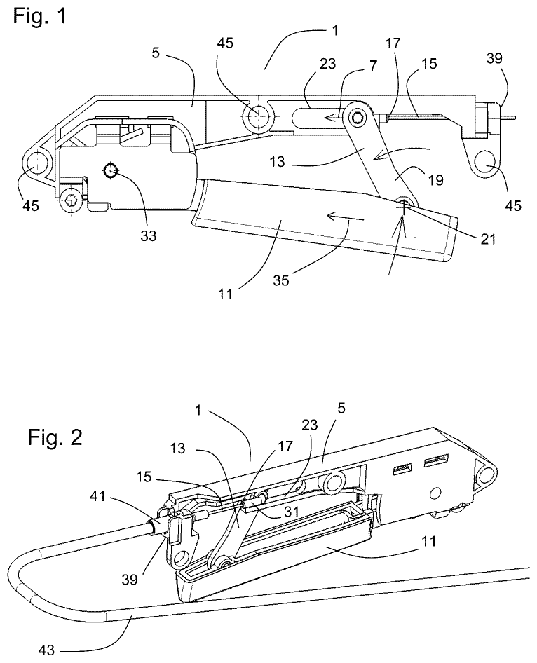

As illustrated in FIGS. 1 to 6, an interior door handle mechanism 1 for a vehicle 3 comprises a support 5 extending according to a main axis 7, the support 5 being configured to be mounted to a receiving location 9 made within an interior lining of the vehicle 3.

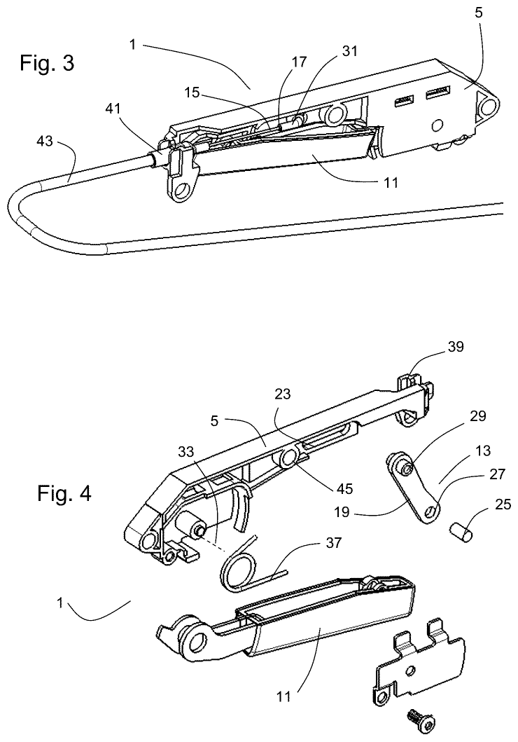

The interior door handle mechanism 1 for a vehicle 3 comprises a moving grip 11 configured to cooperate with the support 5, the moving grip 11 being movable between a rest position as in FIG. 2 and a pulled position as in FIG. 3 with respect to the support 5.

The interior door handle mechanism 1 for a vehicle 3 comprises a linear pulling device 13 arranged to cooperate with the support 5 and the moving grip 11.

The linear pulling device 13 is also arranged to link the moving grip 11 and an opening cable 15 of the vehicle 3. The linear pulling device 13 is configured to pull on the opening cable 15 by displacing a connection point 17 of the opening cable 15 with the linear pulling device 13 according to the main axis 7 only when the moving grip 11 is moved from the rest position to the pulled position.

In other words, the linear pulling device 13 enables to displace the opening cable 15 linearly according to the main axis 7. The opening cable 15 presents a connection point 17 which cooperates with the linear pulling device 13 and which is displaced linearly.

The movement of the moving grip 11 is then transformed in a linear movement for applying a tension on the opening cable 15.

As the opening cable 15 is moved linearly, the linear pulling device 13 can be small and easy to integrate within the vehicle 3.

The interior door handle mechanism 1 can then be applied to doors or compartments of the vehicle whose opening or openable state is triggered by an opening cable 15 of the vehicle 3.

The opening cable 15 is a steel cable or a cable in a material with properties equivalent to the properties of steel.

The linear pulling device 13 comprises a lever 19 rotatably mounted on the moving grip 11 so as to rotate around a rotation axis 21 that is transversal to the main axis 7, the lever 19 being arranged to cooperate with a linear guide 23 of the support 5 that extends according to the main axis 7.

The lever 19 is a unique intermediate element between the moving grip 11 and the support 5. The moving grip 11 is provided with a rotation axle 25 that extends according to the rotation axis 21 and that is configured to cooperate with a rotation opening 27 of the lever 19.

The linear guide 23 is an oblong opening within the support 5, the lever 19 presenting a translation axle 29 configured to be guided within the oblong opening.

When the lever 19 rotates, the translation axle 29 is moving according to the main axis 7 between the rest position and the pulled position. The translation axle 29 comprises a fixation 31 arranged to cooperate with the connection point 17 of the opening cable 15.

The moving grip 11 is rotatably mounted on the support 5, the moving grip 11 being movable between the rest position and the pulled position according to an actuating axis 33 with respect to the support 5.

It appears that the rotating movement of the moving grip 11 is transformed by the linear pulling device 13 into a linear displacement of the opening cable 15. This advantageous configuration enables to have a small interior handle mechanism 1 in particular transversally to the main axis 7. Indeed, the support 5 extends mainly according to the main axis 7.

In addition, as the moving grip 11 moves, the rotation axis 21 also moves around the actuating axis 33. Thus, when the moving grip 11 is manually displaced between the rest position and the pulled position, the lever 19 is displaced, one end by rotation and the other by translation, so as to pull on the opening cable 15.

The moving grip 11 present an overall elongated form extending according to a corresponding extension axis 35, said extension axis 35 forming an angle with the main axis 7 that is getting smaller when moving from the rest position to the pulled position.

This provision enables to easily place the interior handle mechanism 1 within the vehicle as a supplementary space is not needed for the moving grip 11 when moving towards to the pulled position. Indeed, the interior handle mechanism 1 takes less space in pulled position.

The interior handle mechanism 1 comprises a return element 37 configured to cooperate with the support 5 and with the moving grip 11 so as to move the moving grip 11 in the rest position when the moving grip 11 is not moved manually.

This provision facilitates the use of the interior handle mechanism 1 as by default the moving grip remains or moves to the rest position.

The return element 37 is a torsion spring, each extremity of the torsion spring being configured to cooperate with a corresponding shoulder of the support 5 and the moving grip 11. The torsion spring is configured to move its extremities around the actuating axis 33.

The support 5 includes an adapter 39 configured to fix a fitting 41 of a sheath 43 of the vehicle 3 receiving the opening cable 15.

The adapter 39 also extends transverse to the rotation axis 21 and the actuating axis 33. As the sheath 43 is fixed to the adapter 39, in absence of a solicitation, the opening cable 15 is maintained by the lever 19 and the sheath 43 by the adapter 39 so that the lever 19 always has the same orientation. This defines the rest position.

The adapter 39 presents a slot for inserting the fitting 41 of the sheath 43 and shoulders to prevent a move from the fitting transversally to the slot. The slot enables to install manually the fitting 41 and withdraw it if necessary.

The support 5 presents at least one fixation opening 45 for installation within the vehicle 3. The support 5 is a part that remains fixed with respect to the rest of the vehicle 3. The at least one fixation opening 45 enables to install the support 5 within the vehicle 3 thanks to corresponding fixing means as screws. The at least one fixation opening 45 is extending in parallel to the actuating axis 33 and to the rotation axis 21.

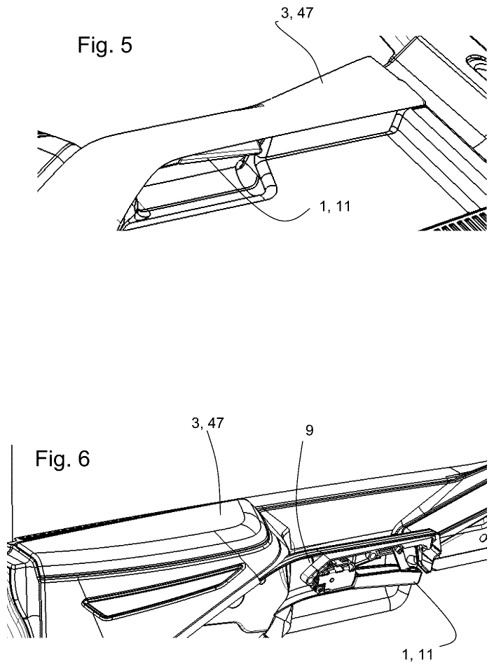

As illustrated in FIGS. 5 and 6, the vehicle 3 has an interior part 47, here a door, that has one receiving location 9 wherein the interior handle mechanism 1 is received so that a part of the moving grip 11 is accessible in the rest position.

The overall design of the interior part 47 hides almost every part of the interior handle mechanism 1 for its protection except a part of the moving grip 11 which is visible and accessible by a user.

In other words, said part of the moving grip 11 extends from the receiving location 9 in the rest position. In pulled position, the moving grip 11 is pushed within the receiving location 9 by the user to pull the opening cable 15.

The interior part 47 is a handle assembly including electronics configured to lock and unlock a closing mechanism of a door, the interior handle mechanism being also configured to lock and unlock said closing mechanism.

The interior handle mechanism is a redundant mechanism that can be used when the electronics is not working, for example during a failure of the vehicle. Due to its geometry, the interior handle mechanism 1 can be installed in a discreet place so that the handle assembly appears as the main command to open the door.

As goes without saying, the invention is not limited to the sole embodiment described above by way of example, it encompasses all the variants.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An interior door handle mechanism for a vehicle comprising:
a support extending according to a main axis, the support being configured to be mounted to a receiving location made within an interior lining of the vehicle;
a moving grip configured to cooperate with the support, the moving grip being movable between a rest position and a pulled position with respect to the support; and
a linear pulling device arranged to cooperate with the support and the moving grip, the linear pulling device being arranged to link the moving grip and an opening cable of the vehicle, the linear pulling device being configured to pull on the opening cable by displacing a connection point of the opening cable with the linear pulling device according to the main axis only when the moving grip is moved from the rest position to the pulled position.

2. The interior door handle mechanism according to claim 1, wherein the linear pulling device comprises a lever rotatably mounted on the moving grip so as to rotate around a rotation axis that is transversal to the main axis, the lever being arranged to cooperate with a linear guide of the support that extends according to the main axis.

3. The interior door handle mechanism according to claim 2, wherein the linear guide is an oblong opening within the support, the lever presenting a translation axle configured to be guided within the oblong opening.

4. The interior door handle mechanism according to claim 1, wherein the moving grip is rotatably mounted on the support, the moving grip being movable between the rest position and the pulled position according to an actuating axis with respect to the support.

5. The interior door handle mechanism according to claim 4, wherein the moving grip presents an overall elongated form extending according to a corresponding extension axis, said extension axis forming an angle with the main axis that is getting smaller when moving from the rest position to the pulled position.

6. The interior door handle mechanism according to claim 1, comprising a return element configured to cooperate with the support and with the moving grip so as to move the moving grip in the rest position when the moving grip is not moved manually.

7. The interior door handle mechanism according to claim 1, wherein the support includes an adapter configured to fix a fitting of a sheath of the vehicle receiving the opening cable.

8. The interior door handle mechanism according to claim 1, wherein the support presents at least one fixation opening for installation within the vehicle.

9. An interior part of a vehicle, comprising:
the interior door handle mechanism according to claim 1,
wherein the interior part has one receiving location wherein the interior door handle mechanism is received so that at least a part of the moving grip is accessible in the rest position.

10. The interior part of the vehicle according to claim 9, wherein said interior part is a handle assembly including electronics configured to lock and unlock a closing mechanism of a door, the interior door handle mechanism being also configured to lock and unlock said closing mechanism.
